(19) United States
(12) Patent Application Publication
(10) Pub. No.: US 2014/0027366 A1
(43) Pub. Date: Jan. 30, 2014

(54) TOP LOAD FILTER WITH EXTERIOR DRAIN ACTUATION

(71) Applicant: CUMMINS FILTRATION IP, INC., Minneapolis, MN (US)

(72) Inventors: Charles W. Hawkins, Sparta, TN (US); Ismail C. Bagci, Cookeville, TN (US); Peter K. Herman, Stoughton, WI (US); Scott W. Schwartz, Cottage Grove, WI (US)

(73) Assignee: CUMMINS FILTRATION IP, INC., Minneapolis, MN (US)

(21) Appl. No.: 13/867,262

(22) Filed: Apr. 22, 2013

Related U.S. Application Data
(60) Provisional application No. 61/676,502, filed on Jul. 27, 2012.

(51) Int. Cl. B01D 29/13; B01D 35/30

(52) U.S. Cl. CPC B01D 29/13; B01D 35/30
USPC 210/232; 210/450; 210/435; 210/436; 137/15.01

(57) ABSTRACT

A cartridge top load filter design and filter element useable with the filter are described that allows fluid to be drained from the filter housing, from the exterior of the housing and without first removing the filter element or the housing cover. The draining feature can be manually activated by a knob that is accessible from the exterior of the filter housing adjacent to the removable cover. The draining feature does not require any tools to activate, and provides a “clean service” option of draining fluid before opening the filter housing.

### FIELD

A cartridge top load fluid filter housing that is provided with the ability to drain the fluid filled chamber of the housing prior to filter element servicing, from outside the housing and without removing the housing cover.

### BACKGROUND

Current spin-on filter designs typically have no convenient way of draining the filter for service. A common practice is to punch a hole in the bottom of the spin-on filter housing with a sharp object to allow the fluid to be drained out. Some fluid filter modules do have the ability to drain the filter housing, but only when the filter element or the cover are removed. In addition, some fuel modules have drain valves that are very difficult to access due to engine components in close proximity to module.

### SUMARY

A cartridge top load fluid filter design is described that allows fluid to be drained from the filter housing, from the exterior of the housing and without first removing the filter element or the housing cover. In the described examples, the draining feature is manually activated by a knob that is accessible from the exterior of the filter housing adjacent to the removable cover. However, the draining feature could be manually activated using other mechanisms accessible from other locations on the exterior of the housing. Regardless of how manual activation occurs, the draining feature does not require any tools (although a tool may be used to help manually activate the knob). In the case of oil as the fluid, the draining feature provides a “clean service” option of draining oil back to the engine block or to a collection pan before opening the filter housing.

In one embodiment, a method of draining fluid from a cartridge top load fluid filter housing is described. The filter housing has a cover removably attached to a housing base with a filter element installed within the housing, and a drain port adjacent to a bottom of the housing base. The method includes, with the cover attached to the housing base, displacing the filter element from a first position to a second position within the filter housing. At the first position, fluid is prevented from flowing through the drain port and at the second position fluid is permitted to flow through the drain port. The displacement of the filter element from the first position to the second position occurs from outside of the filter housing without removing the cover.

In the described examples, the displacement of the filter element occurs from the top of the housing. In the described examples, the displacement is accomplished by incorporating an actuation knob accessible from outside the filter housing that when manually actuated creates upward axial displacement of the filter element from the first position to the second position to open a drain port that drains the filter housing, without opening the cover. After the housing is drained, the cover can be removed and the filter element extracted from the housing with minimal fluid spillage and less mess than would be otherwise possible.

The method of draining fluid described herein is unique, as is the filter housing construction and the filter element construction.

The filter element can include a ring of filtration media having a first end and a second end and circumscribing a central cavity having a longitudinal axis. A first endplate is sealingly attached to the first end of the filtration media, and a second endplate is sealingly attached to the second end of the filtration media. The second endplate has a standpipe opening through which a standpipe can extend and a gasket disposed in the standpipe opening for sealing engagement with a standpipe extending through the standpipe opening. The second endplate can also have a perimeter edge, and a sleeve extending from the second endplate in a direction away from the first endplate parallel to the longitudinal axis. The sleeve has a diameter greater than a diameter of the standpipe opening so that the sleeve surrounds the standpipe opening. The sleeve has one end connected to the second endplate at a location between the standpipe opening and the perimeter edge and an opposite end spaced from the one end. A radial outward facing seal is disposed adjacent to the opposite end of the sleeve so that the radial outward facing seal is disposed at a radial position between the longitudinal axis and the perimeter edge.

A top load cartridge design with filter element drain actuation features (e.g. a knob or a cap) integrated into the lid is also described.

The lower end of the drain actuation knob seals (for example, radially as illustrated or optionally axially via a face seal) with the filter element endplate to prevent flow bypass and interfacing/mating with an extension on the standpipe or the center tube to provide lateral support to the filter element to center the filter element and provide strength to withstand radial vibration forces.

The lower end of the drain actuation knob interfaces with an extension on the standpipe to prevent an incorrect filter element from being installed (e.g. a filter element without the central hole in the endplate and/or sealing engagement surface to mate with the valve).

Optionally, a reverse configuration can also be used whereby a post-like or cylinder-like extension on the knob can engage with the center tube or the standpipe to provide similar lateral support, centering, strength to withstand radial vibration forces, and incorrect filter installation functions.

It is contemplated that the draining and filter concepts described herein could be used in a number of applications including, but not limited to, oil, fuel, or other liquid applications where drainage of a housing prior to service is desired.

### DRAWINGS

FIG. 1 illustrates a first embodiment of a filter housing with an installed filter element at the first or closed position.

FIG. 2 illustrates the filter housing of FIG. 1 with the filter element displaced to the second or open position allowing draining of fluid.

FIG. 3 illustrates the filter housing of FIG. 1 with the filter element and the cover removed from the filter housing.

FIG. 4 is a cross-sectional view of the filter element of FIG. 1.

FIG. 5 is a cross-sectional view of the cover of FIG. 1.

FIG. 6 is a perspective view of the standpipe used in the filter housing of FIG. 1.

FIG. 7 illustrates a second embodiment of a filter housing with an installed filter element at the second or open position.

FIG. 8 illustrates the filter housing of FIG. 7 with the filter element and the cover removed from the filter housing.

FIG. 9 is a cross-sectional view of the filter element of FIG. 7.

FIG. 10 is a cross-sectional view of the cover of FIG. 7.

FIG. 11 is a perspective view of the standpipe used in the filter housing of FIG. 7.

FIG. 12 is a side view of a valve shaft used in the cover of FIG. 10.

FIG. 13 is a detailed cross-sectional view of the first or upper endplate of the filter element of FIG. 9.

FIG. 14 illustrates another embodiment of a filter housing with an installed filter element at the first or closed position.

### DETAILED DESCRIPTION

The described embodiments describe a fluid filter that allows fluid in the filter housing to be drained from the filter housing, from the exterior of the housing and without first removing the filter element or the housing cover. In the described examples, a simple hand-operated knob is used to open the fluid drain port, with no special tool requirements. The lower portion of knob applies axial pressure on the filter element which keeps the filter element at a first position to close the drain port during normal operation. Actuation of the knob permits the filter element to displace to a second position to open the drain port and allow the fluid to drain. The knob is sealed by means of a face seal at the knob/cover interface and the drain port is sealed by a radial seal between a lower endplate of the filter element and the filter housing.

The concepts described herein could be used in a number of applications including, but not limited to, oil, fuel, or other engine fluids, or other liquid applications where drainage of a housing prior to service (for example, replacement of the filter element) is desired. One particular exemplary application illustrated in the drawings is for an oil filter and draining oil from the filter housing back to the oil pan. However, unless the particular fluid or application is specifically identified, it is contemplated that the concepts described herein could apply to fluids and applications other than oil.

The filter element is an integral link between the knob and the drain port. In the described examples, an extension to the standpipe post interfaces with the knob and is used for alignment and structural support, and which also prevents an incorrect filter element (i.e. an element without the central hole on the top endplate which interfaces with the knob) from being misapplied to the filter housing. Alternatively, an extension projecting downward from the knob could interface with the top of the standpipe or center tube.

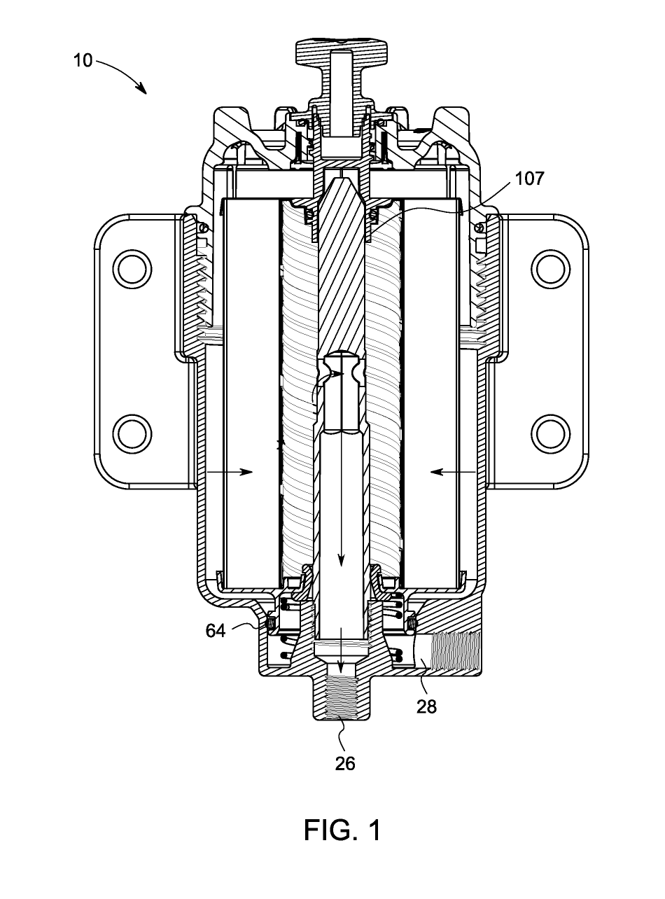

In the example illustrated in FIGS. 1-6, the knob is turned counterclockwise which allows the spring to displace the filter element upward to open the drain port.

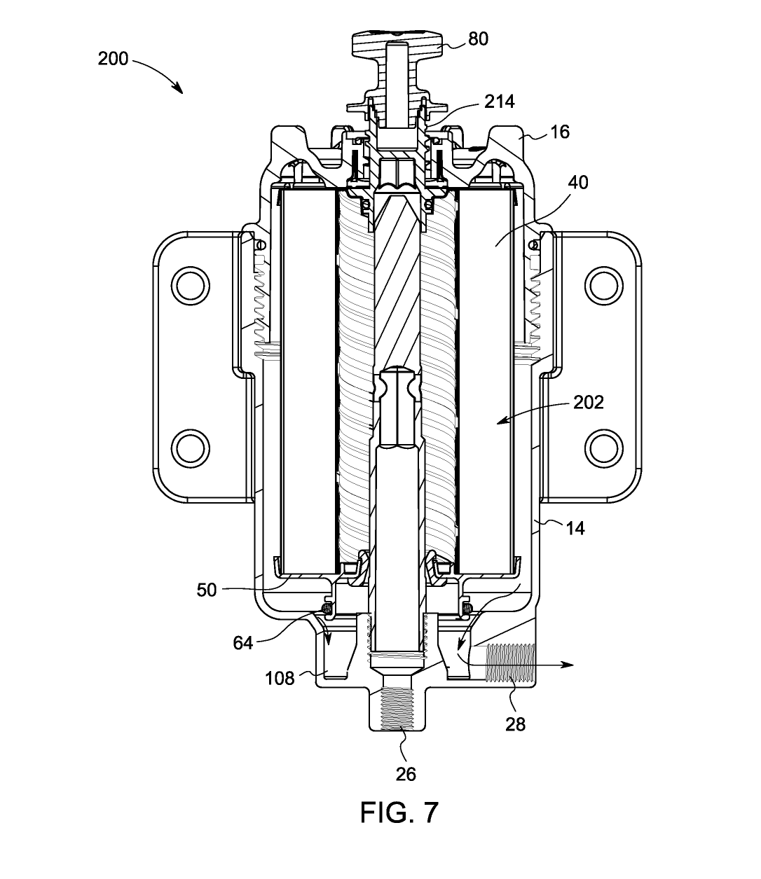

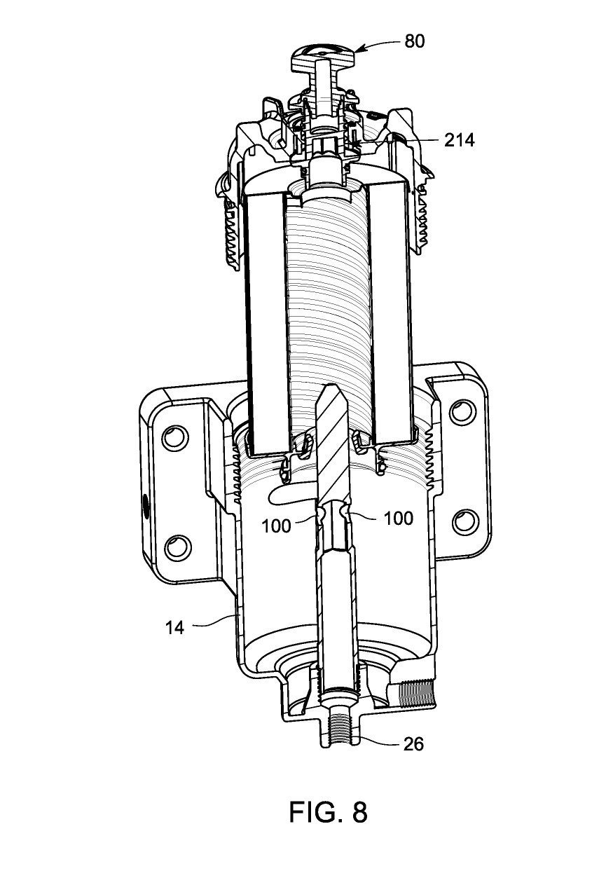

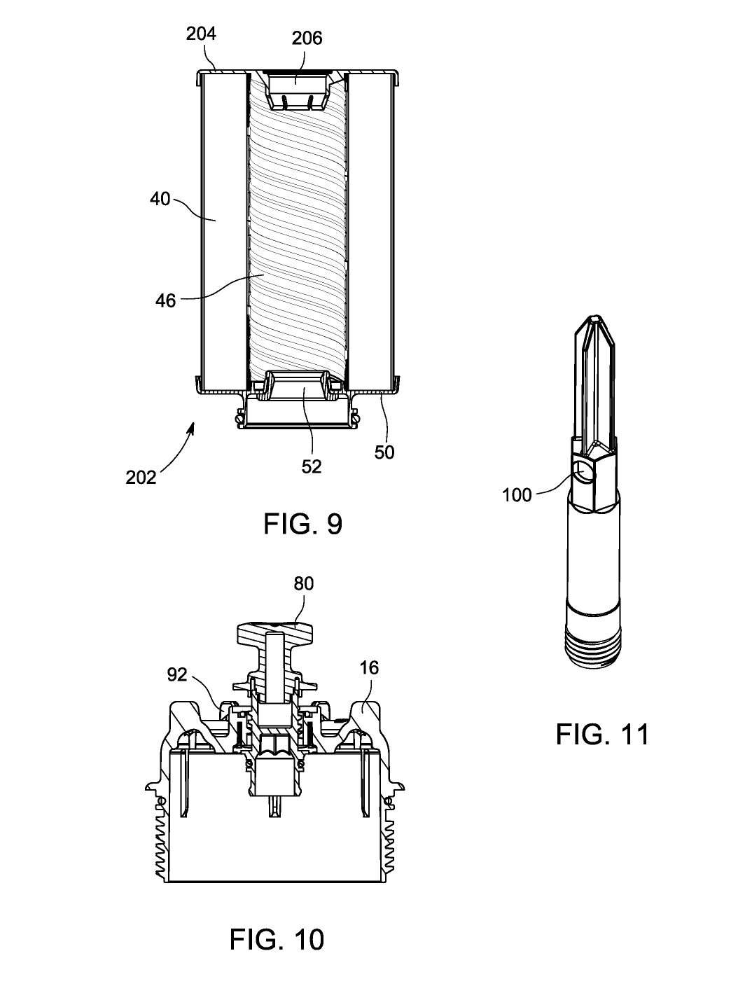

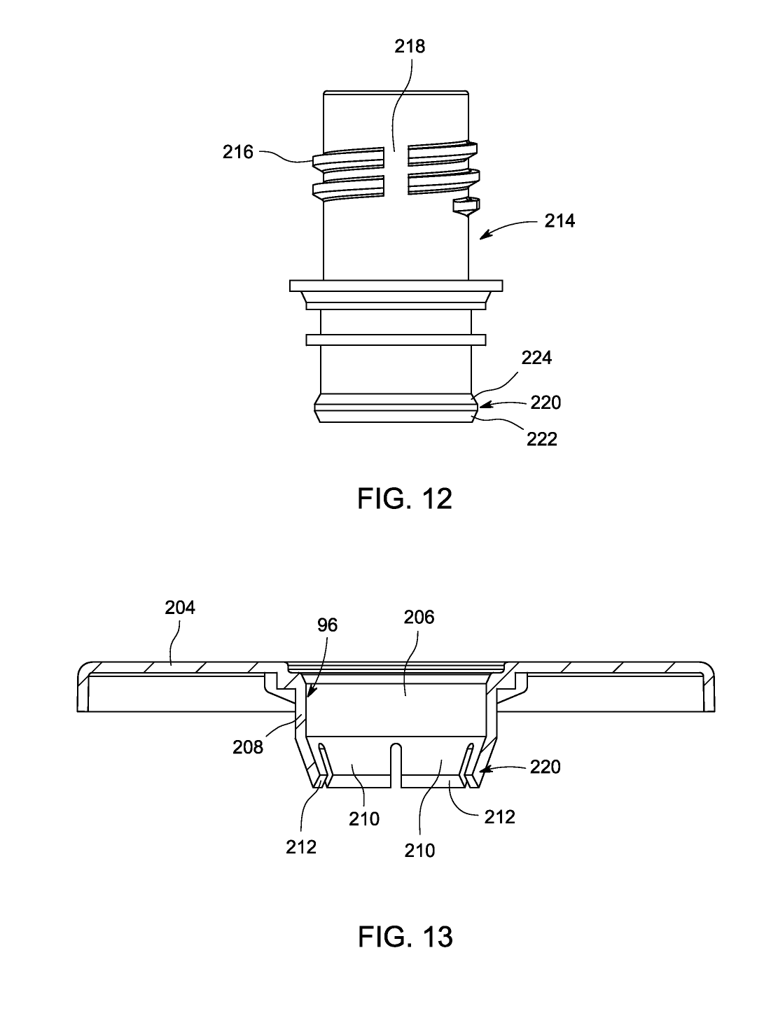

In the example illustrated in FIGS. 7-13, a retention feature is incorporated on the lower component of the knob assembly that engages the filter element top endplate, pulling the filter element up without spring assistance.

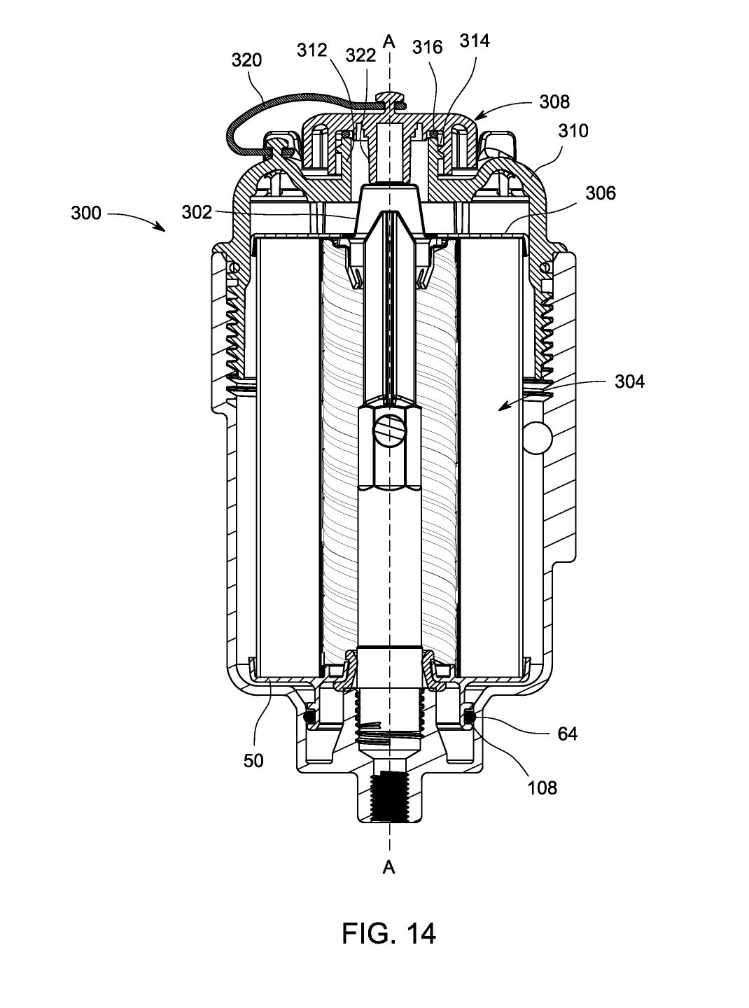

In the example illustrated in FIG. 14, a protrusion on the filter element upper endplate engages with the cover. The filter element is forced downward against spring pressure during normal operation. To drain, the operator removes a simple threaded (or ¼-turn) cap which vents the system and allows the protrusion and the filter element to displace upward, opening the lower drain port. After replacing the filter element, the cap could be reinstalled either before or after reinstalling the cover. The pocket created in the cap could also be used to hold a slow-release fluid additive.

Each of the examples in FIGS. 1-14 can utilize an “extension” to the standpipe (or center tube) which engages with the inner diameter of the knob assembly projecting through the filter element endplate to provide an alignment feature for the filter element, and to provide structural support for resisting radial vibration forces.

In the example illustrated in FIGS. 7-13, the filter element would be extracted with the cover when the cover is removed after draining The filter element could then be disengaged from the retention feature on the cover via radial force on the bottom of filter element relative to the cover. Optionally, the filter element could be disengaged from the cover by the user further rotating (for example counterclockwise) the knob, causing the inner element to “stop out” against the cover, after which any additional rotation of the knob would cause detachment of the snap feature, freeing the filter element from the cover, and assisting with the clean-service experience (i.e. no touch of the filter element).

### FIGS. 1-6

With reference to FIGS. 1-6, a cartridge top load filter 10 is illustrated. The filter 10 includes a cartridge top load filter housing 12 composed of a housing base 14 and a cover 16 removably attached to the housing base, for example using threads 18. During normal use, a filter element 20 is installed within the housing.

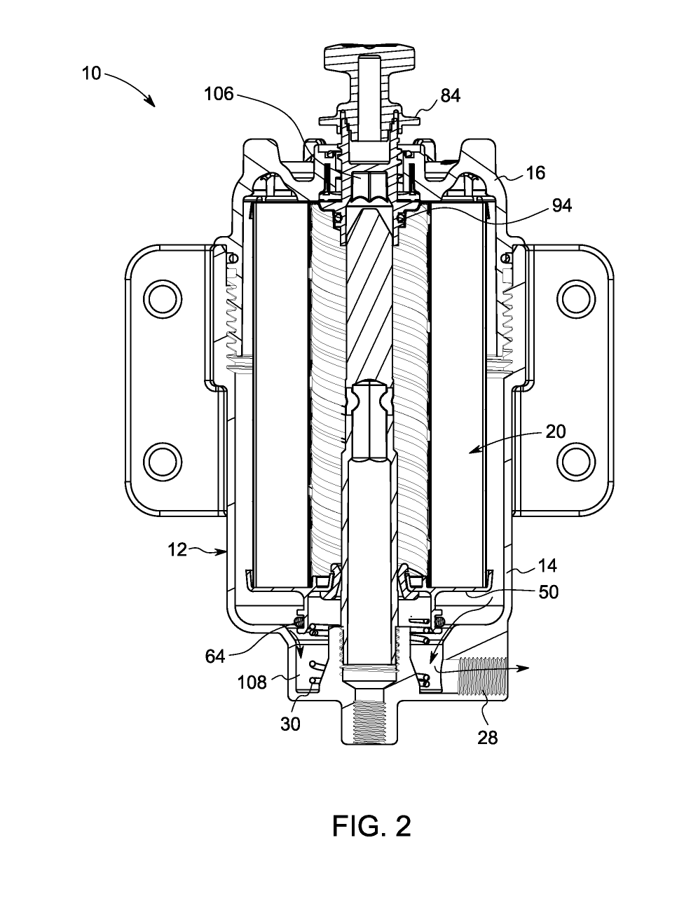

With reference to FIGS. 1-3, the housing base 14 includes a standpipe 22, a fluid inlet 24 through which fluid enters the housing 12 to be filtered, a clean fluid outlet 26 through which filtered fluid exits the filter 10, and a drain port 28 adjacent to a bottom of the housing base 14. A coil spring 30 is disposed around the standpipe 22 which in use applies an upward biasing force on the filter element 20 to bias the filter element in a direction toward the second or open position shown in FIG. 2.

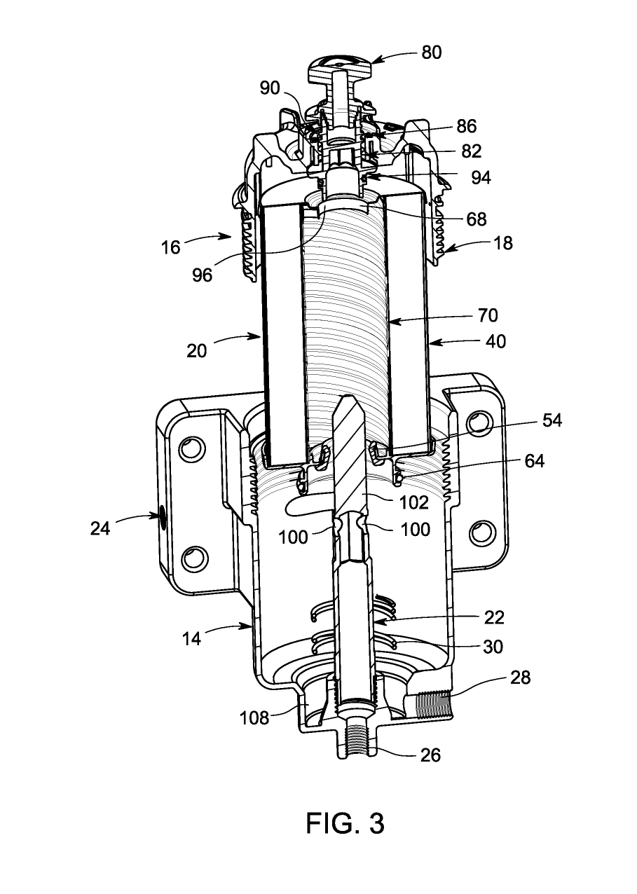

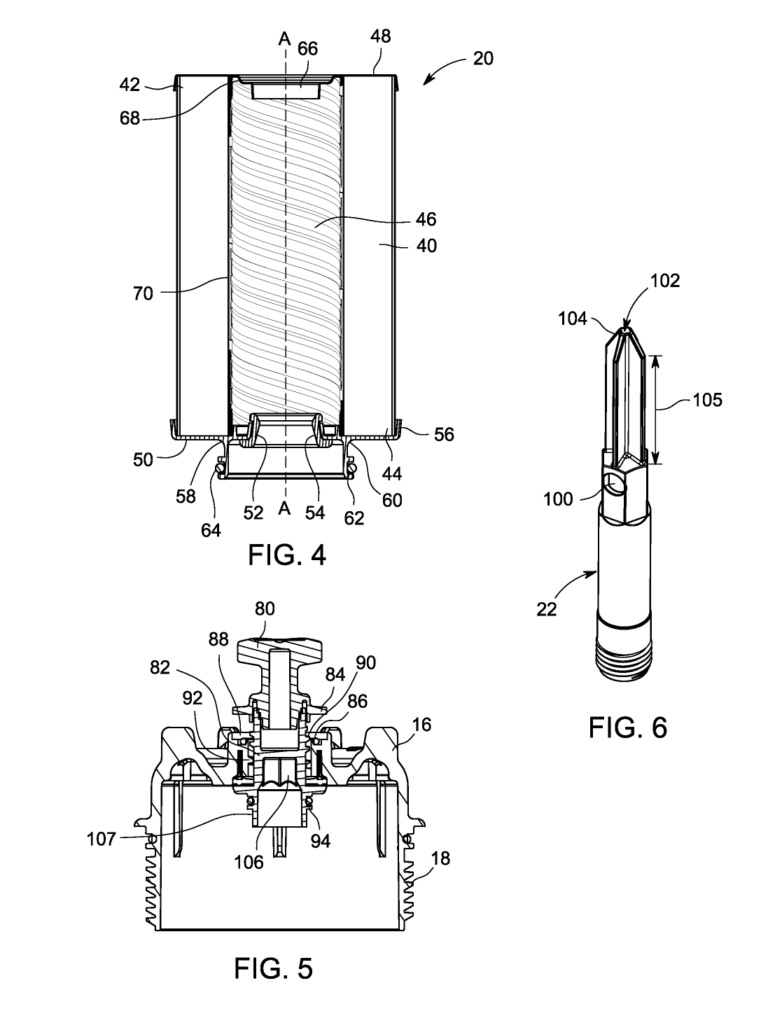

With reference to FIGS. 3 and 4, the filter element 20 includes a ring of filtration media 40 having a first end 42 and a second end 44 and circumscribing a central cavity 46 having a longitudinal axis A-A. A first endplate 48 is sealingly attached to the first end of the filtration media, and a second endplate 50 is sealingly attached to the second end of the filtration media.

The second endplate 50 includes a standpipe opening 52 through which the standpipe 22 can extend and a gasket 54 disposed in the standpipe opening 52 for sealing engagement with the standpipe extending through the standpipe opening. The endplate 50 also includes a perimeter edge 56, and a sleeve 58 extending from the second endplate in a direction away from the first endplate parallel to the longitudinal axis A-A. The sleeve 58 has a diameter greater than the diameter of the standpipe opening 52 so that the sleeve 58 surrounds the standpipe opening. The sleeve has a first end end 60 connected to the second endplate at a location between the standpipe opening and the perimeter edge and an opposite or second end 62 spaced from the first end 60. A radial outward facing seal 64, for example an o-ring seal, is disposed adjacent to the second end 62 of the sleeve. The radial outward facing seal 64 is disposed at a radial position between the longitudinal axis A-A and the perimeter edge 56.

The first endplate 48 includes an opening 66 therethrough defined by a sleeve 68 that extends from the first endplate into the central cavity 46 in a direction toward the second endplate. The opening 66 in the first endplate is aligned with the standpipe opening 52 in the second endplate.

The filter element 20 further includes a perforated center tube 70 that extends between and is fixed at each end thereof to the endplates 48, 50.

With reference to FIGS. 2, 3 and 5, the cover 16 includes a knob 80 that is fixed to a valve shaft 82 that extends through the cover. The knob 80 includes a flange 84 that, in the closed position, seals with a knob seal 86 located in a recessed flange receiving area 88 in the cover 16. The outer diameter of the valve shaft 82 includes threads 90 that engage with threads 92 formed on the cover passageway through which the valve shaft extends. As the valve shaft 82 is rotated by turning the knob 80 in one direction (for example counterclockwise), the valve shaft 82 is caused to displace in a direction upward out of the cover. Conversely, as the valve shaft is rotated by turning the knob in the other direction (for example, clockwise), the valve shaft 82 is caused to displace in a direction inward into the cover. Preferably, the knob 80 and valve shaft 82 assembly are fixed together to form a single structure, and they cannot be readily removed from the cover 16.

The valve shaft 82 also includes a radial valve shaft seal 94 that engages and seals with a radial sealing surface 96 on the sleeve 68 of the endplate 48 as shown in FIG. 2. The seal 94 prevents fluid flow between the filter element 20 and the valve shaft 82. The valve shaft 82 also includes a vent feature as discussed further below with respect to FIGS. 7-13.

With reference to FIGS. 2-3 and 6, the standpipe 22 is generally hollow and includes one or more fluid openings 100 therein through which fluid that has been filtered by the filter element 20 flows to reach the clean fluid outlet 26. The upper end of the standpipe is provided with an alignment feature 102 that is configured to interface/mate with the lower end of the valve shaft 82 to provide lateral support to the filter element 20, to help center the filter element, and provide strength to withstand radial vibration forces.

In the illustrated example, the alignment feature 102 comprises a fluted post that extends upwardly from the top end of the standpipe 22. The fluted post has a primary outer diameter section 105 along the majority of its length, and then tapers in diameter near its tip end 104. The tapered tip end 104 helps guide the filter element into correct position during installation into the filter housing. With reference to FIG. 1, when the filter element is at its first position, the tip end 104 fits into a correspondingly shaped hole 106 formed in the valve shaft 82 while a portion of the primary outer diameter section 105 of the fluted post fits within a lower section 107 of the valve shaft 82. With reference to FIG. 2, when the filter element displaces to its second position, the fluted post is still disposed within the lower section 107 of the valve shaft to help stabilize the filter element during draining

The operation of the filter 10 is as follows. During use, the filter 10 is arranged as illustrated in FIG. 1. In this configuration, which can be termed the closed configuration of the filter, the filter element 20 is in its first or closed position at which the seal 64 on the sleeve 58 seals with a sealing surface 108 on the housing base 14. This prevents fluid from reaching the drain port 28. Instead, all fluid to be filtered that enters the filter housing flows radially inward through the filter media 40 into the central cavity 46, into the opening(s) 100 in the standpipe, and then out through the clean fluid outlet 26 as shown by the arrows in FIG. 1.

When the filter 10 is to be serviced, for example replacement of the filter element 20, the fluid within the filter housing is first drained prior to opening the filter housing by removing the cover 16. Draining is achieved by rotating the knob 80 in the appropriate direction, for example counterclockwise. This causes the valve shaft 82 to axially displace upward in the direction of the longitudinal axis. As this occurs, the spring 30 biases the filter element 20 axially upward to axially displace the filter element to its second or open position shown in FIG. 2. At this position, the seal 64 no longer seals with the sealing surface 108. This allows fluid within the housing to flow past the endplate 50, as shown by the arrows, and out the drain port 28 which can be fluidly connected to a sump or other fluid collection location.

Once the fluid has been drained, the cover 16 can be removed from the housing base 14, and the old filter element replaced with a new filter element. The cover 16 is then reattached to the housing base. The knob 80 can be rotated clockwise to return it and the valve shaft 82 to their original position shown in FIG. 1 before reattaching the cover 16 or after the cover has been reattached to the housing base.

### FIGS. 7-13

With reference to FIGS. 7-13, a second embodiment of a cartridge top load filter 200 is illustrated. The filter 200 has many similarities to the filter 10, but eliminates the biasing spring 30 used in the filter 10 and instead employs a snap fit connection design between the valve shaft and the upper endplate of the filter element which causes the filter element to displace axially with the valve shaft when the knob is rotated. The construction and operation of the filter 200 is otherwise identical to the filter 10.

In FIGS. 7-13, elements identical to elements in the filter 10 will be referenced using the same reference numerals. However, only those features that are different will be described in detail.

With reference to FIGS. 7-9 and 13, the filter element 202 of the filter 200 includes a first endplate 204 that includes an opening 206 therethrough defined by a sleeve 208 that extends from the first endplate into the central cavity in a direction toward the second endplate 50. The opening 206 in the first endplate is aligned with the standpipe opening 52 in the second endplate.

The end of the sleeve 208 includes a plurality of circumferentially spaced, inwardly angled snap fingers 210 each of which has an angled ramp surface 212.

With reference to FIGS. 7-8, 10 and 12, the knob 80 is fixed to a valve shaft 214. The valve shaft 214 includes threads 216 that engage with the threads 92 on the cover passageway through which the valve shaft extends. The threads 216 are interrupted to form at least one channel 218 which allows venting of air during draining which aids in draining A similar vent feature is used in FIGS. 1-6 described above and in FIG. 14 described below.

In addition, the end of the shaft 214 is formed with an enlarged diameter end 220 having a first ramp surface 222 and a second ramp surface 224. In use, the valve shaft 214 snap fit engages with the endplate 204. To attach, the end of the valve shaft 214 is inserted into the opening 206. As this occurs, the first ramp surface 222 engages the snap fingers 210 which forces the fingers outwardly to allow the enlarged diameter end 220 to pass the fingers 210. Once past the fingers, the fingers 210 snap fit behind the end 220 on the second ramp surface 224.

The operation of the filter 200 is generally similar to the filter 10. During use, the filter 200 would be arranged similarly to that illustrated in FIG. 1 with the filter element 202 located at its first or closed position (not shown) with the seal 64 sealed with the sealing surface 108. This prevents fluid from reaching the drain port 28. Instead, all fluid to be filtered that enters the filter housing flows radially inward through the filter media 40 into the central cavity 46, into the opening(s) 100 in the standpipe, and then out through the clean fluid outlet 26.

When the filter 200 is to be serviced, for example replacement of the filter element 202, the fluid within the filter housing is first drained prior to opening the filter housing by removing the cover 16. Draining is achieved by rotating the knob 80 in the appropriate direction, for example counterclockwise. This causes the valve shaft 214 to axially displace upward in the direction of the longitudinal axis. Since the valve shaft 214 is snap fit connected to the filter element, the filter element 202 displaces axially upward with the valve shaft to its second or open position shown in FIG. 7. At this position, the seal 64 no longer seals with the sealing surface 108. This allows fluid within the housing to flow past the endplate 50, as shown by the arrows in FIG. 7, and out the drain port 28 which can be fluidly connected to a sump or other fluid collection location.

At the second or open position, the endplate 204 is close to or is in contact with the cover 16. Continued rotation of the knob 80 in the counterclockwise direction continues to force the filter element upward against the cover. As this occurs the angled ramp surfaces 212 ride along the second ramp surface 224 to deflect the snap fingers 210 radially outward to release the snap connection to disconnect the filter element from the valve shaft. This disconnection of the filter element from the valve shaft can occur with the cover 16 attached to the housing base 14. Alternatively, the cover can be removed from the housing base together with the knob assembly and the filter element. The knob can then be rotated as described above to detach the filter element from the valve shaft. This allows the servicing to be performed clean without the service technician touching the wet filter element.

A new filter element can then be installed. The new filter element can be attached to the valve shaft prior to re-attaching the cover, or the new filter element can first be installed in the housing base and then the cover re-attached, with the valve shaft being attached to the filter element during re-attachment of the cover.

### FIG. 14

With reference to FIG. 14, another embodiment of a cartridge top load filter 300 is illustrated. The filter 300 has many similarities to the filter 10, but eliminates the knob and valve shaft used in the filter 10. Instead, the filter 300 employs a protrusion 302 on the filter element 304 upper endplate 306 that engages with a cap (or knob) 308 rotatably attached to the cover 310. The construction and operation of the filter 300 is otherwise identical to the filter 10. In FIG. 14, elements identical to elements in the filter 10 will be referenced using the same reference numerals. However, only those features that are different will be described in detail.

The protrusion 302 extends upwardly in a direction away from the endplate 50 parallel to the longitudinal axis A-A and into a neck region 312 formed on the cover 310. The endplate 306 is solid and does not permit fluid flow therethrough. The outer perimeter of the neck region 312 is formed with exterior threads 314 which engage with interior threads 316 formed on the cap 308. The cap 308 includes a protrusion 322 that extends downwardly from a central portion thereof and into engagement with the top end of the protrusion 302 as shown in FIG. 14.

As illustrated in FIG. 14, the cap 308 is fully threaded onto the cover 310, which forces the filter element 304 downward against the pressure of the spring (not shown) during normal operation where the seal 64 seals with the sealing surface 108 to prevent draining of fluid. To drain, the servicing technician unscrews the cap 308, which permits the filter element to displace axially upward due to the biasing force of the spring to unseat the seal 64 from the sealing surface 108. Fluid can then flow past the endplate 50 and to the drain port (not illustrated).

The cap 308 can be a ¼ turn cap that remains attached to the neck region 312 of the cover and requiring only roughly a ¼ or ½ turn to provide enough displacement of the filter element to allow draining Alternatively, the cap 308 can be completely removable from the neck region. In either case, a tether 320 can be used to tether the cap 308 to the cover 310.

After replacing the filter element 304, the cap 308 could be reinstalled either before or after reinstalling the cover 310. The pocket created in the cap could also be used to hold a slow-release fluid additive container.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of draining fluid from a cartridge top load filter housing having a cover removably attached to a housing base with a filter element installed within the housing, and a drain port adjacent to a bottom of the housing base, the method comprising:
with the cover attached the housing base, displacing the filter element from a first position to a second position within the filter housing, at the first position fluid is prevented from flowing through the drain port and at the second position fluid is permitted to flow through the drain port, and the displacement of the filter element from the first position to the second position occurs from outside of the filter housing without removing the cover.

2. The method of claim 1, wherein the filter element moves in a longitudinal direction within the filter housing when moving from the first position to the second position.

3. The method of claim 1, wherein displacing the filter element from a first position to a second position comprises rotating a knob that is rotatably attached to the cover to displace the knob relative to the cover in a longitudinal direction, the knob is engaged with a top endplate of the filter element at the first position and at the second position, and a spring is engaged with the filter element and biases the filter element in a direction toward the second position.

4. The method of claim 1, wherein displacing the filter element from a first position to a second position comprises rotating a knob that is rotatably attached to the cover to displace the knob relative to the cover in a longitudinal direction and that is fixed to the filter element to pull the filter element from the first position to the second position when the knob is displaced in the longitudinal direction.

5. The method of claim 1, wherein displacing the filter element from a first position to a second position comprises rotating a knob that is rotatably attached to the cover to displace the knob relative to the cover in a longitudinal direction, the knob is engaged with a top endplate of the filter element at the first position and at the second position, and a spring is engaged with the filter element and biases the filter element in a direction toward the second position.

6. The method of claim 1, further comprising removing the cover from the housing base.

7. The method of claim 6, comprising removing the filter element.

8. A filter element, comprising:
a ring of filtration media having a first end and a second end and circumscribing a central cavity having a longitudinal axis;
a first endplate sealingly attached to the first end of the filtration media;
a second endplate sealingly attached to the second end of the filtration media, the second endplate including:
a standpipe opening through which a standpipe can extend and a gasket disposed in the standpipe opening, the gasket is positioned to seal with a standpipe extending through the standpipe opening;
a perimeter edge;
a sleeve extending from the second endplate in a direction away from the first endplate parallel to the longitudinal axis, the sleeve has a diameter greater than a diameter of the standpipe opening so that the sleeve surrounds the standpipe opening, the sleeve has one end connected to the second endplate at a location between the standpipe opening and the perimeter edge and an opposite end spaced from the one end;
a seal disposed adjacent to the opposite end of the sleeve, the seal is disposed at a radial position between the longitudinal axis and the perimeter edge.

9. The filter element of claim 8, wherein the seal is a radial outward facing seal.

10. The filter element of claim 8, wherein the first endplate includes an opening therethrough defined by a second sleeve that extends from the first endplate into the central cavity in a direction toward the second endplate, the opening in the first endplate is aligned with the standpipe opening in the second endplate.

11. The filter element of claim 10, wherein the second sleeve includes a plurality of circumferentially spaced snap fingers.

12. The filter element of claim 8, wherein the first endplate includes a protrusion that extends therefrom in a direction away from the second endplate parallel to the longitudinal axis, the protrusion is coaxial to the longitudinal axis, and the first endplate is solid and does not permit fluid flow therethrough.

13. The filter element of claim 8, wherein the filtration media is designed to filter an engine fluid.

14. The filter element of claim 8, wherein the filtration media is designed to filter oil or fuel.

15. A cartridge top load filter, comprising:
a filter housing having a cover removably attached to a housing base, the housing base and the cover defining an interior space that in use receives a filter element;
a drain port formed in the housing base;
a standpipe attached to the housing base and extending upwardly therefrom in a direction toward the cover; and
a manually actuatable knob rotatably attached to the cover and extending through the cover, the knob including a first, gripping portion located outside the filter housing and a second portion located inside the interior space at a position to engage with a filter element installed therein.

16. The cartridge top load filter of claim 15, wherein the second portion is hollow, and the standpipe includes an alignment feature that is disposed inside the second hollow portion when the cover is attached to the housing base.

17. The cartridge top load filter of claim 16, wherein the alignment feature comprises a fluted post with a tapered tip end that is disposed inside the second hollow portion.

18. The cartridge top load filter of claim 15, wherein the first, gripping portion comprises a knob.

19. The cartridge top load filter of claim 15, wherein the second portion comprises threads that engage with threads on the cover, and an air vent channel formed in the threads.
